(19) United States
(12) Patent Application Publication
(10) Pub. No.: US 2005/0080675 A1
(43) Pub. Date: Apr. 14, 2005

(54) System and method for automated dynamic wait listing

(75) Inventors: Kenneth J. Lovegreen, Lake Kiowa, TX (US); Mark A. Johnson, Cedar Hill, TX (US); Geoffrey P. Wossum, Coppell, TX (US); Russell P. Blink, Plano, TX (US)

Correspondence Address: Steven W. Smith, Attorney, 7237 Birchwood Drive, Dallas, TX, 75240-3609, US

(73) Assignee: Long Range Systems, Inc.

(21) Appl. No.: 10/681,987

(22) Filed: Oct. 9, 2003

(51) Int. Cl. G06F 17/60

(52) U.S. Cl. 705/15

(57) ABSTRACT

A system and method for adding a customer's name to a waiting list at a selected restaurant. A central waiting list database stores waiting list information for a plurality of participating restaurants. The waiting list information indicates waiting times associated with each participating restaurant and each waiting customer. Local waiting list databases located at each participating restaurant are connected to the central database through a data network such as the Internet. The central database and the local databases periodically exchange information regarding the waiting customers and their associated waiting times at each participating restaurant. A Website connected to the central database and the network enables an accessing customer to review restaurant information for the participating restaurants, select a restaurant, determine the waiting time at the selected restaurant, and add the customer's name to the waiting list for the selected restaurant.

### TECHNICAL FIELD OF THE INVENTION

The present invention is related to automated restaurant management systems. More particularly, and not by way of limitation, the present invention is directed to a system and method providing a Website and messaging service through which customers can add their names to waiting lists or reservation lists at participating restaurants.

### BACKGROUND OF THE INVENTION

Some restaurants accept reservations and some do not. Traditionally, to make a reservation, a customer places a telephone call to the restaurant and is added to the reservation list by restaurant personnel. For restaurants that do not accept reservations, customers have traditionally had to arrive at the restaurant unannounced, and hope that a table is available. If a table is not available, the customer is added to a waiting list. If asked, the hostess may give the customer an estimate of the current waiting time.

Recently, some restaurants have begun to accept what is referred to as “call-ahead seating”. With call-ahead seating, a customer may call the restaurant, and if there is currently a waiting list, he can request that the hostess add his name to the waiting list. Thereafter, when the customer travels to the restaurant, he does not have to wait as long for a table to become available. Furthermore, if the hostess tells the customer the current waiting time when he calls, the customer may time his trip so that he arrives at the restaurant when his table is supposed to be ready.

However, there are still a number of disadvantages with call-ahead seating. First, if a customer wants to determine the waiting time at several restaurants so that he can pick the restaurant with the shortest waiting time, he must look up the telephone number for each restaurant and individually call each restaurant to enquire about the waiting time. He then has to call back the restaurant that had the shortest waiting time. This process may take considerable time, especially if some of the phone numbers are busy. Second, if the customer wants to check several restaurants that serve a particular type of food, he may have to refer to an advertising source such as his local “yellow pages” directory. Third, if the restaurant he chooses is one that is new to him, he may have to take further time to ask the restaurant hostess for directions. Fourth, the process is not only a burden on the customer, but is also a burden on the restaurant hostess who must take all of these incoming calls while also trying to greet and seat customers already at the restaurant.

It would be advantageous to have a system and method providing a Website and messaging service through which customers can add their names to waiting lists or reservation lists at participating restaurants in a more efficient and user-friendly manner. The present invention provides such a system and method.

### SUMMARY OF THE INVENTION

In one aspect, the present invention is directed to a method of enabling a customer to add the customer's name to a waiting list at a selected restaurant. The method includes the step of storing information in a central waiting list database regarding each customer waiting to be seated at one of a plurality of participating restaurants. The information indicates waiting times associated with each participating restaurant and each waiting customer. The method also includes interfacing the central waiting list database with a local database located at each participating restaurant for exchanging information regarding customers waiting to be seated and the associated waiting time at each participating restaurant; providing a Website through which a customer can access the central waiting list database; and receiving from the customer, an indication of a selected restaurant. The method further includes the steps of providing the customer upon request with an estimated waiting time for the selected restaurant; and determining whether the customer requests to be added to the waiting list for the selected restaurant, If the customer does not request to be added to the waiting list for the selected restaurant, the method provides the customer with the ability to select other restaurants from the plurality of participating restaurants. If the customer requests to be added to the waiting list for the selected restaurant, the method adds the customer to the waiting list for the selected restaurant.

In another aspect, the present invention is directed to a system for adding a name of a customer to a waiting list at a selected restaurant. The system includes a central waiting list database that stores waiting list information for a plurality of participating restaurants. The waiting list information indicates waiting times associated with each participating restaurant and each waiting customer. The system also includes a data network connecting the central waiting list database with a local waiting list database located at each participating restaurant. The network enables the central database and the local databases to exchange information regarding the waiting customers and their associated waiting times at each participating restaurant. The system also includes a Website connected to the central waiting list database and the network, said Website enabling an accessing customer to review restaurant information for the participating restaurants, to select a restaurant, to determine the waiting time at the selected restaurant, and to add the customer's name to the waiting list for the selected restaurant.

### BRIEF DESCRIPTION OF THE DRAWINGS

FIG. 1 is a simplified functional block diagram of the preferred embodiment of the system of the present invention; and

FIGS. 2A-2C are portions of a flow chart illustrating the steps of the preferred embodiment of the method of the present invention when a customer accesses the system through the Internet;

FIG. 3 is a flow chart illustrating the steps of the preferred embodiment of the method of the present invention when a customer accesses the system through a telephone;

FIG. 4 is a flow chart illustrating the steps of the preferred embodiment of the method of the present invention when a customer accesses the system locally at a restaurant; and

FIG. 5 is a flow chart illustrating the steps of the preferred embodiment of the method of the present invention when a customer's table is ready.

### DETAILED DESCRIPTION OF EMBODIMENTS

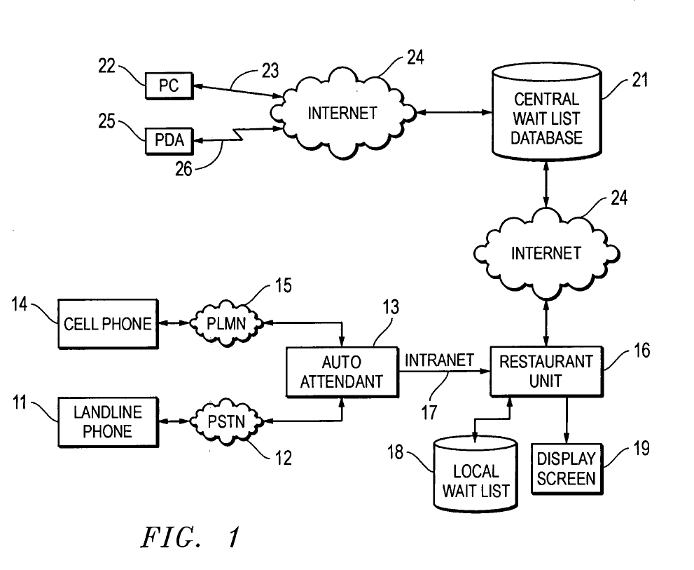

FIG. 1 is a simplified functional block diagram of the preferred embodiment of the system of the present invention. The invention enables customers to add their names to the waiting lists or reservation lists at any of thousands of participating restaurants through several different media. For example, through a landline phone 11 and the Public Switched Telephone Network (PSTN) 12, the customer may reach an auto attendant 13, which may be located at a restaurant. Alternatively, the customer may use a cell phone 14 to access the auto attendant through the Public Land Mobile Network (PLMN) 15. The auto attendant may be connected to a restaurant unit 16 through an intranet connection 17 such as an Ethernet Local Area Network (LAN). The restaurant unit functions as an on-site controller that accesses and updates a local waiting list database 18. The restaurant unit may also control a display screen 19 that displays information regarding the current waiting list. At the option of the restaurant owner, the display screen may be oriented so that customers waiting at the restaurant can view the display and ascertain where they are on the waiting list.

Customers may also add their names directly to a central waiting list database 21 residing on a Website for that purpose. For example, a customer may utilize a personal computer (PC) 22 at his home or office to access the central database through a wireline Internet connection 23 and the Internet 24. Likewise, a mobile customer may utilize a wireless access device such as a Personal Digital Assistant (PDA) 25 to access the Internet through a wireless link 26. The central database 21 is connected through the Internet to each of the restaurant units 16 located at each of the participating restaurants. Periodically, for example every minute, the restaurant unit and the central database synchronize their data (i.e., update each other) regarding customers on the waiting list for the particular restaurant where the restaurant unit is located. In this way, there is always a backup if either the local waiting list database 18 or the central waiting list database go down.

When a customer calls the auto attendant 13 using either his landline phone 11 or his cell phone 14, the auto attendant presents the customer with a menu of options. For example, an announcement may ask the customer to dial various numbers depending on whether the customer wants to speak to a hostess, hear the restaurant's waiting time, hear the customer's current waiting time (if already on the list), or receive directions to the restaurant. If the customer desires to hear the current waiting time, he may be prompted to provide additional information such as the size of his party, and preference information such as smoking or non-smoking. These factors are considered in the system's calculation of the current waiting time. Other factors may include, for example, the time of day, the day of the week, whether it is a holiday, time of occupation for tables where parties are currently seated, party size of parties currently seated, distribution of table sizes within the restaurant, and whether the wait staff and/or kitchen staff is at full strength. The system may utilize a progressive learning program to calculate the waiting time.

The customer may additionally provide a time at which he desires to be added to the waiting list. The restaurant unit 16 stores this information, and at the appropriate time, adds the customer's name to the local waiting list 18.

The auto attendant 13 may utilize a feature such as calling line identification (CLID) to identify the customer when the customer calls the restaurant. The first time a customer calls, the customer's CLID is used as an identification to place the customer on the waiting list. Subsequently, if the customer calls again, and requests to hear his current waiting time, the auto attendant again uses the CLID information to identity the customer and match the call with the correct position on the waiting list. The auto attendant then recites the specific estimated waiting time for the customer through stored voice messages.

A customer may access the central waiting list database 21 through the Internet 24, by going to a Website such as click-aheadseating.com. At the Website, the customer may select a restaurant of choice from a list of participating restaurants. The list may be searchable and sortable by type of food, price range, location, and the like. The site may also offer links to the Websites of the participating restaurants where the customer may find the restaurants' menus and/or specials for the day. Alternatively, a link may be added to the restaurant's Website, which links to the central database. Once the customer has selected a restaurant, he is presented with options. The customer may ask for the current waiting time, the customer's current waiting time (if already on the list), or directions to the restaurant. If the customer asks for directions, the system may present a stored map or may provide a link to a map service. If the customer asks to be added to the waiting list, the system may ask the customer to enter information such as the size of the customer's party and preference information such as smoking or non-smoking, indoor or outdoor seating, and the like. The customer's name and preference information is passed to the restaurant unit 16 at the selected restaurant whenever the central database synchronizes its data with the restaurant unit. Thereafter, the customer's current waiting time is refreshed whenever the central database synchronizes its data with the restaurant unit. Thus, if there is a long wait at the selected restaurant, the customer can periodically check the Website to see how much longer the wait is expected to be. The customer may also have the option of cancelling his name from the waiting list if his plans change.

Once the customer's preference information is entered at the Website, the customer may be asked whether he would like for this information to be remembered for the next time that the customer uses the service. If the customer answers affirmatively, the preference information is stored in a memory. The next time the customer uses the service, he may be shown the stored preference information and asked to confirm it or enter any changes. In one embodiment, the Website adds cookies to the customer's computer whenever the customer adds his name to a waiting list. The system may allow the customer to add his name to fewer than a predefined number of waiting lists each day. If the customer then attempts to add his name to multiple waiting lists for multiple restaurants, his attempt may be denied, with an explanation that he can only add his name to the predefined number of waiting lists each day. However, the customer is allowed to enter multiple entries, as long as they are for different days.

The central database may also include a feature that recognizes sister restaurants (i.e., restaurants in a same general area and having the same parent company). If a customer asks for the waiting time for a restaurant having sister restaurants, the system may present him with the waiting time for his selected restaurant and the sister restaurants as well. Sister restaurants may be presented regardless of the way in which the customer accesses the system (i.e., in person at the restaurant, by telephone, or by Internet). Alternatively, the system may present him with the waiting time for the sister restaurants only if the waiting time for his selected restaurant is longer than a predefined threshold, or if the customer indicates that he does not want to be added to the waiting list.

In one embodiment, the customer is asked to enter a telephone number when his name is added to the waiting list. The system may then call back the customer to confirm that he will be added to the list. The system may also call the customer when there is a predefined time period remaining until expiration of the waiting time. For example, the system may call the customer when there is approximately 15 minutes left to wait. The system may also ask the customer to confirm that he still intends to dine at the selected restaurant. This feature may also be implemented for customers calling the auto attendant 13 directly at the restaurant. The customer may also receive a call when the customer's table is ready.

In another embodiment, the customer is asked to enter his address when his name is added to the waiting list. The system then estimates the driving time from the customer's address to the selected restaurant, and places the call to the customer when the estimated driving time equals the time remaining until expiration of the estimated waiting time. When the customer arrives at the restaurant, he can check in with the hostess and inform her that he is on the waiting list. If there is additional waiting time, the hostess can then designate the customer in the system as being in the restaurant.

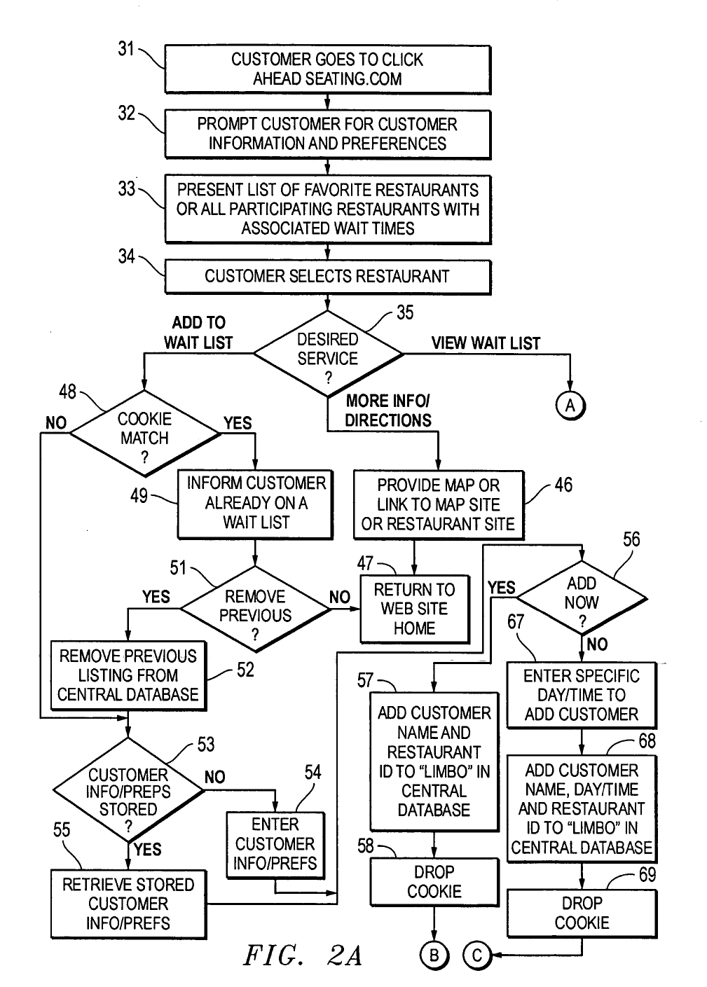

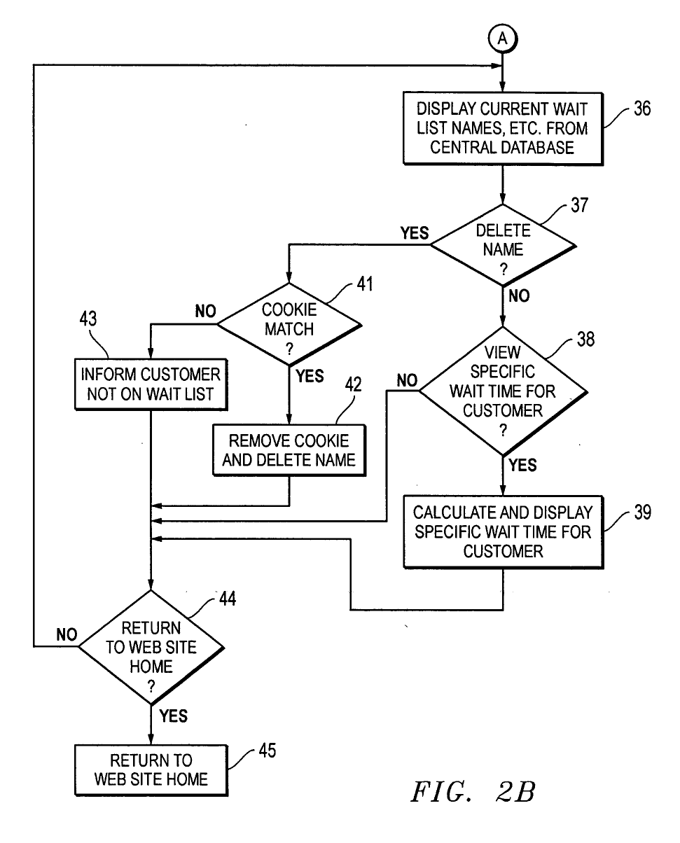

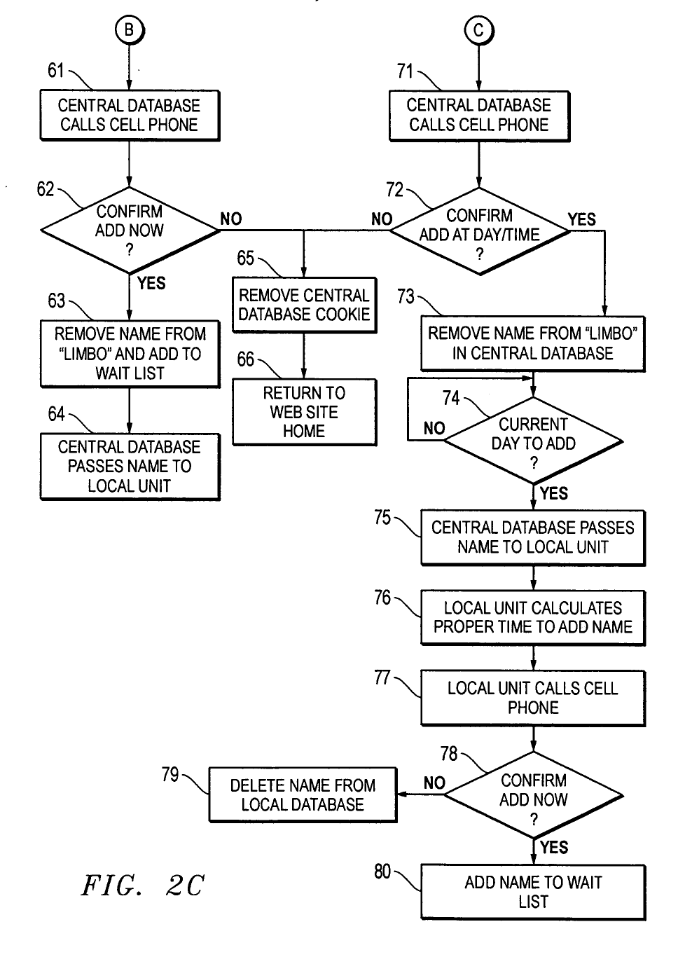

FIGS. 2A-2C are portions of a flow chart illustrating the steps of the preferred embodiment of the method of the present invention when a customer accesses the system through the Internet using, for example, the PC 22 or PDA 25 to access the invention's Website and central waiting list database 21. At step 31, the customer accesses the Website (for example, click-aheadseating.com) where he can browse through the information available for the participating restaurants. At step 32, the system prompts the customer to enter customer information and preferences. The customer information may include such information as a contact cellular telephone number and the size of his party. The customer preferences may include preferences such as smoking or non-smoking, or indoor or outdoor seating. At step 33, the system presents a list of the customer's favorite restaurants (if the customer has previously set up this information) or a list of all participating restaurants together with their associated current average waiting times. At step 34, the customer selects a restaurant. At step 35, the system may then present the customer with several service options, and the customer selects a desired service. In the exemplary embodiment illustrated, the customer may select whether he wants to view the waiting list at the selected restaurant, obtain directions or more information about the selected restaurant, or be added to the waiting list for the selected restaurant.

If the customer has already added his name to the waiting list for the selected restaurant, he may indicates that he would like to view the waiting list at the selected restaurant in order to view his current waiting time. In this case, the method moves to step 36 in FIG. 2B, where the system displays the current waiting list names, etc., from the central database 21. At step 37, the customer indicates whether he wants to delete his name from the waiting list. If not, the system asks whether the customer would like to view his specific current waiting time. If the customer indicates yes at step 38, the method moves to step 39 where the system calculates and displays the specific current waiting time for the customer.

However, if the customer indicates at step 37 that he would like to delete his name from the waiting list, the method moves instead to step 41 where it is determined whether the cookie from the customer's PC matches a cookie associated with a name on the waiting list. If so, the method moves to step 42 where the cookie is deleted and the customer's name is deleted from the waiting list. If the cookies do not match, the method moves instead from step 41 to step 43 where the system informs the customer that he is not currently on this waiting list. If the customer indicates at step 38 that he does not want to view his specific current waiting time, or following any of steps 39, 42, or 43, the method moves instead to step 44 where the customer is asked if he would like to return to the Website home page. If not, the method returns to step 36. If so, the method moves to step 45 and returns to the Website home page.

Referring again to FIG. 2A, if the customer indicates at step 35 that he would like to receive directions to the selected restaurant or more information about the selected restaurant, the method moves to step 46 where the customer is provided with a map and/or directions for getting to the selected restaurant. Alternatively, the Website may include a link to the Website of a map service where the customer can obtain the needed directions. The Website may also include a link to the selected restaurant's Website where the customer can get additional information. The customer may then choose to return to the system's Website home page at step 47.

If the customer selection at step 35 indicates that the customer wants to be added to the waiting list at the selected restaurant, the method moves to step 48 where the system compares the cookie from the customer's PC with the cookies associated with the names that are already on waiting lists in the central database 21. If the customer's cookie matches an already stored cookie, the method moves to step 49 where the customer is informed that his name is already on a waiting list. At step 51, the system asks the customer whether he would like to remove his name from the previous list. If not, the method moves to step 47 and returns to the Website home page. However, if the customer indicates that he wants to remove his name from the previous list, the method moves instead to step 52 where the previous listing is removed from the central database. The method then proceeds to step 53.

Returning again to step 48, if the customer's cookie does not match an already stored cookie, the method moves instead to step 53 where it is determined whether or not the customer's information and preferences are stored in the system. If not, the customer's information and preferences are entered at step 54. However, if the customer's information and preferences are stored in the system, they are retrieved at step 55. The method then moves to step 56 whether the customer wants to add his name to the waiting list now. If so, the method moves to step 57 and adds the customer's name and a restaurant ID to a “Limbo” state in the central database 21. The cookie from the customer's PC is then dropped at step 58. The method then proceeds to step 61 in FIG. 2C.

Referring briefly to FIG. 2C, at step 61 the central database calls the customer at the cellular telephone number entered as part of the customer information. The system then asks the customer at step 62 to confirm that he wants to be added to the waiting list for the selected restaurant now. The customer may indicate yes or no, for example, by pressing 1 or 2 on his phone. If the customer indicates yes, the customer's name is removed from the “Limbo” state at step 63 and is added to the waiting list in the central database 21. The method then moves to step 64 where the central database passes the customer's name to the selected restaurant's restaurant unit 16 for storage in the local waiting list database 18. However, if the customer indicates at step 62 that he does not want to confirm the addition of his name to the waiting list, the method moves instead to step 65 where the central database cookie is removed. The system then returns to the Website home page at step 66.

Referring again to FIG. 2A, if the customer indicates at step 56 that he does not want to add his name to the waiting list at that time, the method moves instead to step 67 where the customer is asked to enter the specific day and time that he would like to add his name to the waiting list for the selected restaurant. At step 68, the system adds the customer's name, the day/time, and a restaurant ID to a “Limbo” state in the central database 21. The cookie from the customer's PC is then dropped at step 69. The method then proceeds to step 71 in FIG. 2C.

At step 71, the central database calls the customer at the cellular telephone number entered as part of the customer information. The system then asks the customer at step 72 to confirm that he wants to be added to the waiting list for the selected restaurant at the day and time that was entered in step 67. The customer may indicate yes or no, for example, by pressing 1 or 2 on his phone. If the customer indicates no, the method moves to step 65 where the central database cookie is removed. The system then returns to the Website home page at step 66. However, if the customer indicates at step 72 that he wants to confirm the addition of his name to the waiting list at the day/time entered, the method moves instead to step 73 where the customer's name is removed from the “Limbo” state in the central database 21. The method then moves to step 74 where it is determined whether the current day is the day to add the customer's name to the waiting list. If not, the system waits until it is the correct day, and then proceeds to step 75 where the central database passes the customer's name to the selected restaurant's restaurant unit 16 for storage in the local waiting list database 18.

At step 76, the local restaurant unit 16 calculates the proper time to add the customer's name to the waiting list. Before doing so, however, the local unit calls the customer at step 77 to confirm that he still wants to be added at that time. If the customer indicates at step 78 that he does not want to confirm, the method moves to step 79 where the customer's name is deleted from the local waiting list database 18. However, if the customer confirms that he wants his name added to the waiting list, the method moves instead to step 80 where the customer's name is added at the calculated time.

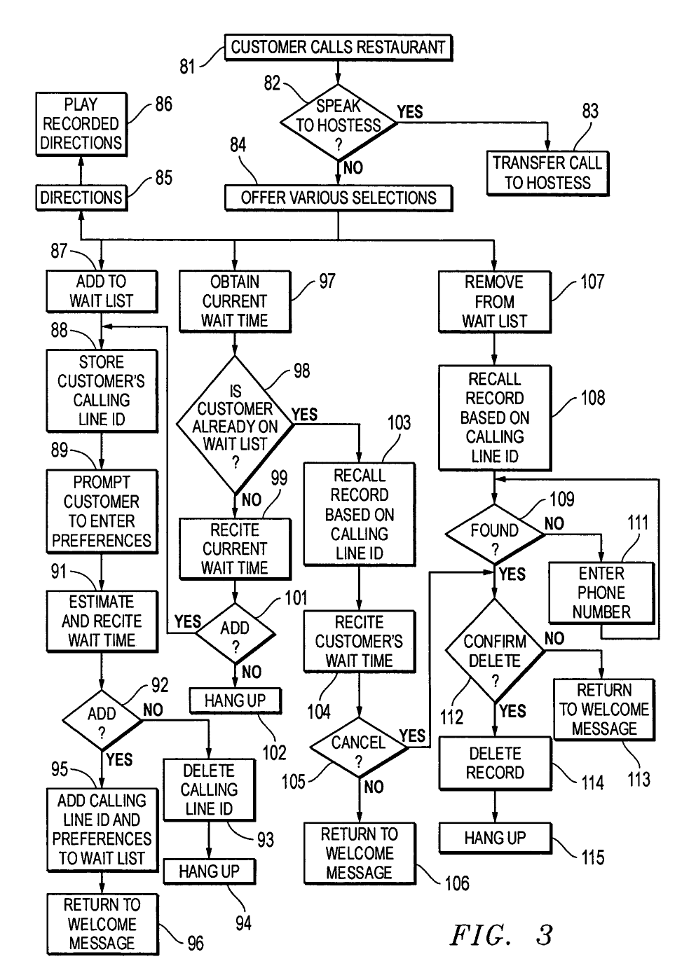

FIG. 3 is a flow chart illustrating the steps of the preferred embodiment of the method of the present invention when a customer accesses the system through a telephone such as the landline phone 11 or cellular phone 14. At step 81, the customer calls the restaurant. At step 82, the auto attendant 13 asks the customer if he wants to speak to a hostess. If so, the call is transferred to the hostess at step 83. If not, the system offers the customer various selections at 84. The customer may be instructed to press various numbers on his phone in order to make his selections. In the exemplary embodiment shown, the customer may select between directions, adding his name to the waiting list, obtaining the current waiting time, or being removed from the waiting list.

If the customer indicates at step 84 that he would like to receive directions to the restaurant, the method moves to step 85. At step 86, the system may play recorded directions to the customer. If the customer indicates at step 84 that he would like to be added to the waiting list, the method moves to step 87. At step 88, the system stores the customer's calling line identification (CLID) to use as an identifier for the customer. At step 89, the system prompts the customer to enter his preferences such as smoking/nonsmoking, indoor/outdoor, and the like. At step 91, the system calculates the estimated waiting time and recites the waiting time to the customer. At step 92, the system asks the customer if he still wants to be added to the list. If not, the CLID is deleted at step 93 and the auto attendant hangs up at 94. If the customer still wants to be added to the list, the method moves to step 95 where the CLID and preferences are added to the local waiting list database 18. At step 96, the system returns to the welcome message, thus providing the customer with the opportunity to make other selections or speak to the hostess.

If the customer indicates at step 84 that he would like to obtain the current waiting time at the restaurant, the method moves to step 97. At step 98, the system determines whether or not the customer is already on the waiting list. This may be done by comparing the customer's CLID with CLIDs stored in the waiting list database 18. If the customer is not already on the waiting list, the method moves to step 99 and recites the current waiting time to the customer. At step 101, the system then asks the customer if he would like to be added to the waiting list. If so, the method returns to step 88 and follows the procedure for adding the customer to the waiting list. If the customer does not want to be added, the method moves instead to step 102 and hangs up. Referring again to step 98, if the customer is already on the waiting list, the method moves to step 103 where the system recalls the customer's record based on the stored CLID. The method then recites the customer's updated waiting time at step 104. At step 105, the system asks the customer if he would like to cancel and be removed from the waiting list. If not, the method moves to step 106 where the system returns to the welcome message, thus providing the customer with the opportunity to make other selections or speak to the hostess. However, if the customer indicates at step 105 that he wants to cancel and be removed from the waiting list, the method moves to step 112 of the removal procedure, as described below.

If the customer indicates at step 84 that he would like to be removed from the waiting list at the restaurant, the method moves to step 107. At step 108, the system attempts to recall the customer's record based on the stored CLID. If the record is not found at step 109, the customer is asked to enter the phone number for the telephone that he used when he was originally added to the waiting list. The system should then be able to make the CLID match. Once the record is found, the system asks the customer at step 112 to confirm that he wants to be removed. If the customer changes his mind and indicates no, the method moves to step 113 where the system returns to the welcome message, thus providing the customer with the opportunity to make other selections or speak to the hostess. However, if the customer indicates at step 112 that he still wants to cancel and be removed from the waiting list, the method moves to step 114 where the customer's record is deleted from the local waiting list database 18. The system then hangs up at step 115.

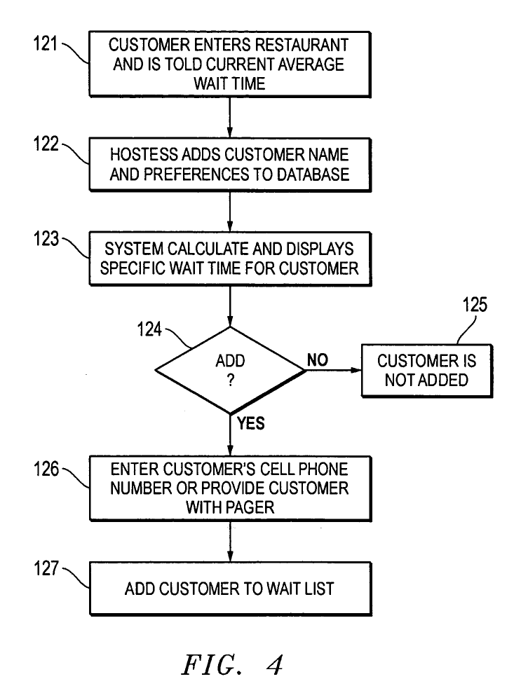

FIG. 4 is a flow chart illustrating the steps of the preferred embodiment of the method of the present invention when a customer accesses the system locally at a restaurant. At step 121, the customer enters the restaurant and is told the current average waiting time. If the customer is interested, the hostess adds the customer's name and preferences to the local waiting list database 18 at step 122. At step 123, the system uses the customer's preferences to calculate a specific waiting time for the customer, which is then displayed. At step 124, the customer determines whether he wants to be added to the waiting list. If he does not, the method moves to step 125, and the customer is not added. Optionally, the hostess may provide the customer with the waiting times at nearby sister restaurants. However, if the customer wants to be added, the method moves instead to step 126 where the hostess enters the customer's cellular phone number in the system, if the customer has a cellular phone, or provides the customer with a pager, if the customer does not have a cellular phone. At step 127, the customer is added to the waiting list.

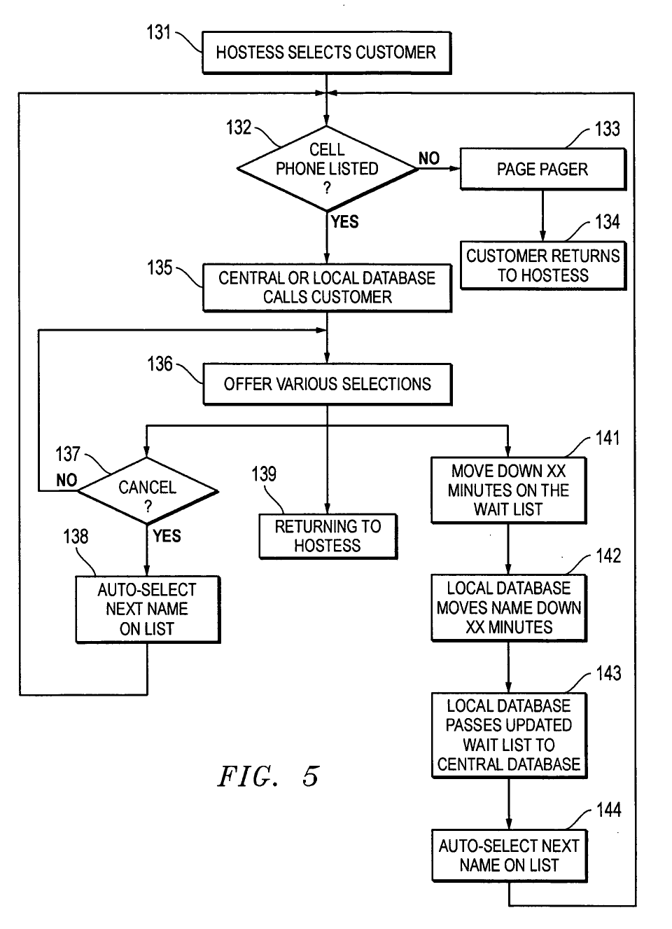

FIG. 5 is a flow chart illustrating the steps of the preferred embodiment of the method of the present invention when a customer's table is ready. At step 131, the hostess selects the customer for an available table. At step 132, it is determined whether a cellular phone number is listed for the customer. If not, the method moves to step 133 where the system pages the pager that was provided to the customer, and the customer returns to the hostess at step 134. However, if a cellular phone number is listed for the customer at step 132, the method moves instead to step 135 where either the central database 21 or the local database 18 calls the customer.

At step 136, the system offers the customer various selections when the customer answers his phone. For example, the customer can select at step 137 to cancel his name from the waiting list. The system may prompt the customer to confirm this selection, and if the customer selects no, the method returns to step 136 where the options are presented again. If the customer confirms the cancellation, however, the method moves instead to step 138 where the system auto-selects the next name on the waiting list with a party that is appropriate for the available table. The method then returns to step 132 and repeats the process for the next appropriate name.

Alternatively, the customer may indicate at step 139 that he is returning to the hostess to be seated. Still again, the customer may indicate at step 141 that he wishes to be moved down the waiting list xx number of minutes. This situation may arise if the customer is still waiting on another member of his party, and he does not want to be placed at the back of the list, or if the customer has temporarily left the restaurant premises, but is returning in xx minutes. At step 142, the local database moves the customer's name down the list by xx minutes. At step 143, the local database passes the updated waiting list to the central database. At step 144, the system auto-selects the next appropriate name on the waiting list for the currently available table. The method then returns to step 132 and repeats the process for the next appropriate name.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

1. A method of enabling a customer to add the customer's name to a waiting list at a selected restaurant, said method comprising the steps of:
storing information in a central waiting list database regarding each customer waiting to be seated at one of a plurality of participating restaurants, said information indicating waiting times associated with each participating restaurant and each waiting customer;
interfacing the central waiting list database with a local database located at each participating restaurant for exchanging information regarding customers waiting to be seated and the associated waiting time at each participating restaurant;
providing a Website through which a customer can access the central waiting list database;
receiving from the customer, an indication of a selected restaurant;
upon request by the customer, providing the customer with an estimated waiting time for the selected restaurant;
determining whether the customer requests to be added to the waiting list for the selected restaurant;
upon determining that the customer does not request to be added to the waiting list for the selected restaurant, providing the customer with the ability to select other restaurants from the plurality of participating restaurants; and
upon determining that the customer requests to be added to the waiting list for the selected restaurant, adding the customer to the waiting list for the selected restaurant.

2. The method of claim 1, wherein the step of interfacing the central waiting list database with a local database located at each participating restaurant includes periodically exchanging information between the central database and each local database.

3. The method of claim 2, wherein the step of periodically exchanging information includes exchanging updated waiting times for each customer, and the step of providing a Website through which a customer can access the central waiting list database also includes providing a Website through which the customer can request the customer's current updated waiting time if the customer previously added the customer's name to the waiting list for a selected restaurant.

4. The method of claim 1, wherein the step of providing a Website through which a customer can access the central waiting list database also includes providing a Website through which the customer can search for restaurants by name or by type of food.

5. The method of claim 4, wherein the step of providing a Website through which a customer can access the central waiting list database also includes providing a Website through which the customer can search for restaurants by location.

6. The method of claim 1, wherein the step of providing a Website through which a customer can access the central waiting list database also includes providing a Website through which the customer can obtain directions to a selected restaurant.

7. The method of claim 1, wherein the step of providing a Website through which a customer can access the central waiting list database also includes providing a Website through which the customer can request that the customer's name be removed from the waiting list for a selected restaurant if the customer previously added the customer's name to the waiting list for the selected restaurant.

8. The method of claim 7, wherein the step of providing a Website through which the customer can request that the customer's name be removed from the waiting list for a selected restaurant includes providing the customer with an opportunity to add the customer's name to the waiting list for a different one of the plurality of participating restaurants.

9. The method of claim 1, wherein the step of providing the customer with an estimated waiting time for the selected restaurant upon request by the customer includes obtaining from the customer, customer information and preference information related to a type of seating requested at the selected restaurant, said customer information and preference information being utilized to improve the accuracy of the estimate of the waiting time.

10. The method of claim 9, further comprising the steps of:
storing the customer's preference information in a memory; and
retrieving the customer's preference information when the customer makes a future access to the Website.

11. The method of claim 9, wherein the step of obtaining customer information and preference information from the customer includes obtaining a contact telephone number for the customer.

12. The method of claim 11, further comprising the step of placing a call to the customer's contact telephone number when a predefined time period remains until the expiration of the estimated waiting time.

13. The method of claim 12, wherein the step of placing a call to the customer's contact telephone number when a predefined time period remains until the expiration of the estimated waiting time includes confirming with the customer that the customer is still coming to the selected restaurant.

14. The method of claim 13, further comprising the steps of:
removing the customer's name from the waiting list for the selected restaurant if the customer indicates that the customer is no longer coming to the selected restaurant;
indicating in the central waiting list databse that the customer is confirmed, if the customer indicates that the customer is still coming to the selected restaurant; and
indicating in the central waiting list databse that the customer is unconfirmed, if the customer does not answer the confirmation telephone call.

15. The method of claim 14, further comprising the step of providing the customer with an opportunity to add the customer's name to the waiting list for a different one of the plurality of participating restaurants, if the customer indicates that the customer is no longer coming to the selected restaurant.

16. The method of claim 12, wherein the step of obtaining customer information and preference information from the customer includes obtaining an address for the customer, and the step of placing a call to the customer's contact telephone number when a predefined time period remains until the expiration of the estimated waiting time includes the steps of:
estimating a driving time from the customer's address to the selected restaurant; and
placing the call to the customer when the estimated driving time equals the time remaining until expiration of the estimated waiting time.

17. The method of claim 9, wherein the step of obtaining customer information from the customer includes obtaining a desired seating time from the customer, and wherein the method also includes the steps of:
storing the desired seating time;
calculating a time to add the customer's name to the waiting list by subtracting the waiting time at the selected restaurant from the time at which the customer desires to be seated; and
adding the customer's name to the waiting list at the calculated time.

18. A system for adding a name of a customer to a waiting list at a selected restaurant, said system comprising:
a central waiting list database that stores waiting list information for a plurality of participating restaurants, said waiting list information indicating waiting times associated with each participating restaurant and each waiting customer;
a data network connecting the central waiting list database with a local waiting list database located at each participating restaurant, said network enabling the central database and the local databases to exchange information regarding the waiting customers and their associated waiting times at each participating restaurant; and
a Website connected to the central waiting list database and the network, said Website enabling an accessing customer to review restaurant information for the participating restaurants, to select a restaurant, to determine the waiting time at the selected restaurant, and to add the customer's name to the waiting list for the selected restaurant.

19. The system of claim 18, wherein the central waiting list database and the local databases are adapted to periodically exchange information between the central database and each local database.

20. The system of claim 19, wherein the periodically exchanged information includes updated waiting times for each customer, and the Website is adapted to enable a customer to request the customer's current updated waiting time if the customer previously added the customer's name to the waiting list for a selected restaurant.

21. The system of claim 18, wherein the Website includes:
means for obtaining customer information and preference information related to a type of seating requested at the selected restaurant; and
means for estimating the waiting time utilizing the customer information and preference information to improve the accuracy of the estimate.

22. The system of claim 21, wherein the means for obtaining customer information and preference information includes a memory in which the customer's preference information is stored, and the Website includes means for retrieving the customer's preference information when the customer makes a future access to the Website.

23. The system of claim 21, wherein the means for obtaining customer information and preference information includes means for obtaining a contact telephone number for the customer, and the system further comprises means for placing a confirmation telephone call to a customer who has added his name to the waiting list for a selected restaurant.

24. The system of claim 23, wherein the means for placing a confirmation telephone call places the call to the customer's contact telephone number when a predefined time period remains until the expiration of the estimated waiting time.

25. A method of enabling a customer to add the customer's name to a waiting list at a selected restaurant, said method comprising the steps of:
receiving a telephone call from the customer with an auto attendant at the restaurant;
determining by the auto attendant, calling line identification information for the customer; and
storing information for the customer in a local waiting list database, said information being indexed in the database with the calling line identification information.

26. The method of claim 25, further comprising the steps of:
receiving a subsequent telephone call from the customer with the auto attendant at the restaurant;
determining by the auto attendant, the identity of the customer by matching calling line identification information from the subsequent telephone call with the calling line identification information stored for the customer in the waiting list database;
estimating an updated waiting time for the customer; and
providing the customer with the updated waiting time.
